(19) United States
(12) Patent Application Publication
(10) Pub. No.: US 2001/0029430 A1
(43) Pub. Date: Oct. 11, 2001

(54) Positional information display system

(76) Inventor: Yasuhiro Tamura, Tokyo (JP)

Correspondence Address: LIMBACH & LIMBACH, LLP, 2001 FERRY BUILDING, SAN FRANCISCO, CA, 94111, US

(21) Appl. No.: 09/728,013

(22) Filed: Nov. 30, 2000

(30) Foreign Application Priority Data
Apr. 6, 2000 (JP) 2000-104689

(51) Int. Cl. G01C 21/26

(52) U.S. Cl. 701/213; 340/988

(57) ABSTRACT

A portable terminal device includes: a position detecting unit for detecting a position on the basis of a GPS signal; an orientation detecting unit for detecting an orientation by a flux gate type magnetic sensor or a geomagnetic sensor; an arithmetically operating unit for correcting the positional information detected by the position detecting unit by the orientation detecting unit; a map information storing unit for storing map information therein; a positional information display unit for displaying the present position decided on the basis of the arithmetically operating unit together with the map information; and display processing unit for subjecting the map information displayed by the positional information display unit to rotation scroll by the amount of changed angle on the basis of an output signal from the orientation detecting unit with a change of orientation of the present position; wherein when the orientation is changed by the movement of the portable terminal device, the map information is rotated by the display processing unit, and the present position of the portable terminal device is displayed on the display portion of the positional information display unit so that the forward moving direction is always directed toward the predetermined specific direction within the plane of the display portion.

### BACKGROUND OF THE INVENTION

1. Field of the Invention

The present invention relates to a positional information display system in which map information, which displays a present position on a display section of a portable terminal device, mainly a portable telephone, rotates in correspondence with a change in orientation due to the movement of the portable telephone.

2. Description of the Related Art

A navigation system which is, for example, mounted on a vehicle and displays a present position on a terminal device utilizes a GPS (global positioning system). The GPS transmits a difference of the arrival time of electric waves from four or more satellites to a user through a control station on the ground and measures the present position. Also, a progressive direction is obtained by, for example, calculating the amount of movement in the integrating system on the basis of signals from a gyro and the GPS. The present position and the progressive direction, which have been measured by the GPS and the gyro, are displayed together with the map data on a monitor.

However, in the above-described navigation system, since the amount of movement of the gyro and the GPS at a speed of about 40 km/h or higher is used, a time difference occurs between a start point (display point) and a measurement point. Also, since the received signals are operated by the integrating system, errors are accumulated. In order to solve the above drawback, correction is added by a signal from the gyro. However, because the signal processing by the gyro per se is conducted by the integrating system, if there is an error in the original information per se, such error is maintained as it is or enlarged and then displayed.

Also, the map data displayed on the monitor displays the present position merely while conducting scroll operation in the forward and backward direction and in the right and left direction with the travel of the vehicle. For that reason, there is a case in which the orientation of the vehicle does not coincide with the travel direction thereof on the map data, resulting in a strange feeling.

In addition, it is difficult to downsize an orientation detecting device, and also because of the integrating system as described above, there occurs unevenness or an error in detection of the orientation. As a result, it is difficult that the conventional position display system is applied to the portable terminal device, in particular, a portable telephone.

### SUMMARY OF THE INVENTION

The present invention has been made to solve the above problems with the conventional device, and therefore an object of the present invention is to provide a positional information display system which is capable of displaying the present position of a user together with map information on a small-sized portable terminal device, mainly on a portable telephone, displays the map information in such a manner that the map information rotates with the orientation movement of the portable terminal device and the forward moving direction of the portable terminal device is always directed to a predetermined specific direction within the plane of the display portion, and also which is capable of correcting the positional information of a GPS receiving portion in accordance with the orientation information from a geomagnetic sensor, to thereby permanently eliminate the accumulation of the error information.

In order to achieve the above object, according to the present invention, there is provided a portable terminal device comprising: position detecting means for detecting a position on the basis of a GPS signal; orientation detecting means for detecting an orientation by a flux gate type magnetic sensor consisting of a sensor substrate in which a magnetic field detection coil substrate and an exciting coil substrate are laminated on the upper and lower surfaces of a sensor core, or a geomagnetic sensor using a hole element, a magnetic resistant element or the like; arithmetically operating means for correcting the positional information detected by said position detecting means by said orientation detecting means; map information storing means for storing map information therein; positional information display means for displaying the present position decided on the basis of said arithmetically operating means together with the map information; and display processing means for subjecting the map information displayed by said positional information display means to rotation scroll by the amount of changed angle on the basis of an output signal from said orientation detecting means with a change of orientation of the present position. When the orientation is changed by the movement of the portable terminal device, the map information is rotated by the display processing means, and the present position of the portable terminal device is displayed on the display portion of the positional information display means so that the forward moving direction is always directed toward the predetermined specific direction within the plane of the display portion.

The orientation detecting means may be formed of the flux gate type magnetic sensor or other geomagnetic sensors. As the flux gate type magnetic sensor, there is a magnetic sensor disclosed by, for example, Japanese Patent Unexamined Publication No. Hei 9-43322 and Japanese Patent Application Laid-open No. Hei 11 -118892. The sensor core may be formed of a plate-shaped amorphous core or a ring-shaped amorphous core. The magnetic field detection coil substrate includes a first detection coil substrate having a coil pattern for formation of an x-axial component magnetic field detection coil and a second detection coil substrate having a coil pattern for formation of a y-axial component magnetic field detection coil. The exciting coil substrate includes an annular coil pattern for formation of an exciting coil. Also, through-holes that are connected to the respective coil patterns are defined in the edge portion of the sensor substrate.

As other geomagnetic sensors, geomagnetic sensors using a hole element or a magnetic resistant element are proposed. Those geomagnetic sensors are small in size to the degree where they can be mounted on the portable terminal device and are rich in sensitivity.

The magnetic sensor decomposes the geomagnetism into an x-axial direction magnetic field component and a y-axial direction magnetic field component and outputs those components as an orientation signal of an analog value. The orientation signal is converted into a digital signal and then arithmetically processed to calculate an angle (orientation angle) between the orientation of the present place and an orientation of the present place in case where a magnetic north orientation is 0 degree.

Then, the display processing means displays the map information specified by the position detecting means in such a manner that the map information is rotated in a required direction with the orientation angle as a rotating angle so that the forward moving direction of the portable terminal device is always directed toward the predetermined specific direction within the plane of the display portion, for example, an upper side direction.

The positional information display means includes not only visual display means for an image, a character and so on, but also auditory display means. With this structure, the present position and/or the forward moving state are visually and auditorially displayed.

When the map information displayed by the positional information display means is rotationally processed by the display processing means, the character contained in the map information maintains the positional relation before the map information is rotationally processed in the above specified direction. Also, the positional information display means displays the shortest route or a required period of time up to a destination.

### BRIEF DESCRIPTION OF THE DRAWINGS

These and other objects, features and advantages of this invention will become more fully apparent from the following detailed description taken with the accompanying drawings in which:

FIG. 1 is a block diagram showing the outline of a system in accordance with an embodiment of the present invention;

FIG. 2 is an exploded explanatory diagram showing an example of a magnetic sensor;

FIG. 3 is an explanatory diagram showing a magnetic vector for obtaining a rotating angle of map information;

FIG. 4 is an explanatory diagram showing the map information of a present position specified by GPS;

FIG. 5 is an explanatory diagram showing a map which is sectioned and selected from the map information shown in FIG. 4 on the basis of an orientation angle, which shows processing steps of the map information by a map information display processing portion; and

FIG. 6 is an explanatory diagram showing a map in a state where the selected map shown in FIG. 5 is rotated on the basis of the orientation angle.

### DETAILED DESCRIPTION OF THE PREFERRED EMBODIMENTS

Now, a description will be given in more detail of a preferred embodiment of the present invention with reference to the accompanying drawings.

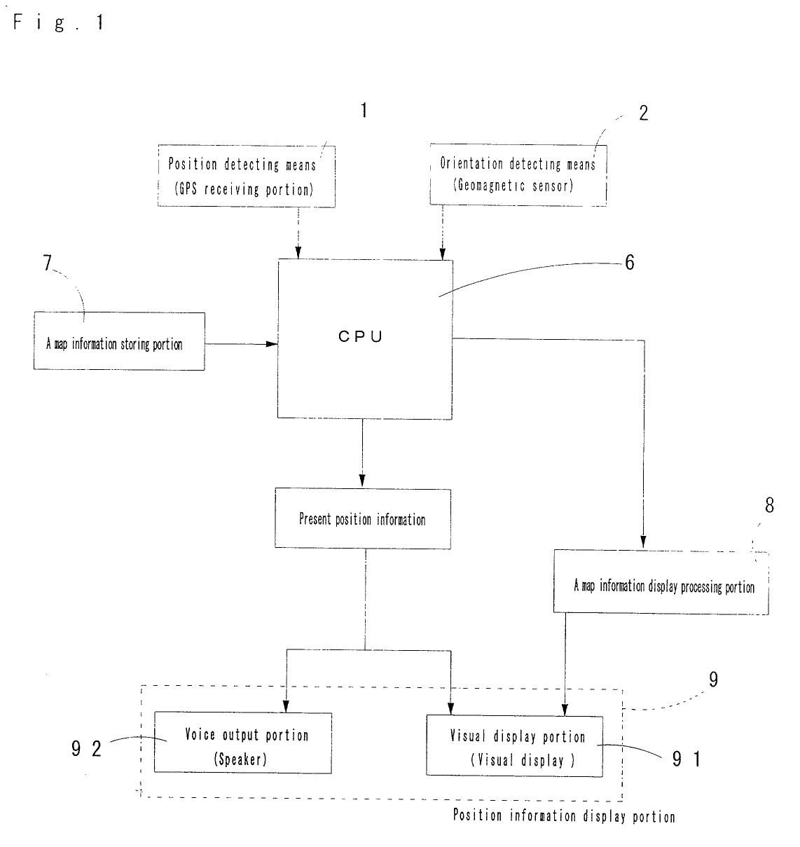

FIG. 1 is a block diagram showing a system in accordance with an embodiment of the present invention, which is mounted on a portable telephone. In the figure, reference numeral 1 denotes a GPS receiving portion that functions as position detecting means which calculates the present longitude and latitude by electric waves of a GPS satellite which are received by an antenna.

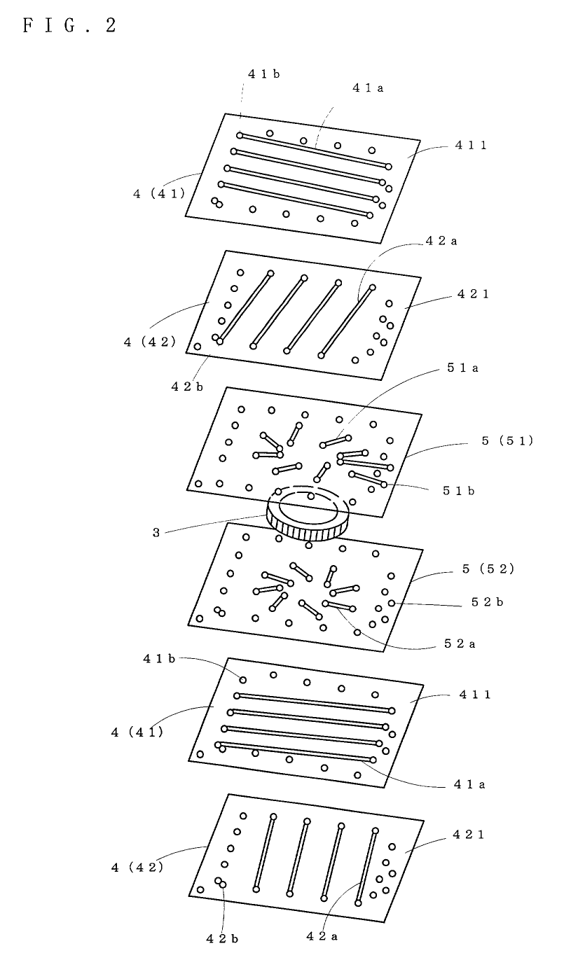

Reference numeral 2 denotes a geomagnetic sensor that functions as orientation detecting means which is formed of a sensor substrate in which a magnetic field detection coil substrate 4 and an exciting coil substrate 5 are laminated on the upper and lower surfaces of a sensor core 3 so as to be opposed to each other. FIG. 2 shows the exploded diagram of a specific example of the magnetic sensor.

The sensor core 3 is formed of an amorphous core resulting from cutting an amorphous thin plate into a ring shape and then etching the ring plate so that a toroidal core is wound on the ring plate.

The magnetic field detection coil substrate 4 is formed of a first detection coil substrate 41 having coil patterns 41a for formation of an x-axial component magnetic field detection coil and a second detection coil substrate 42 having coil patterns 42a for formation of a y-axial direction component magnetic field detection coil. The first detection coil substrate 41 includes two x-coil substrates 411 which are laminated on each other in a conducting manner so as to sandwich the sensor core 3 from the upper and lower sides thereof. Each of those x-coil substrates 411 is formed in such a manner that the coil patterns 41a for formation of the x-axial direction component magnetic field detection coil are formed on a surface of an epoxy substrate, and through-holes 41b for terminals that connect the respective x-coil patterns 41a are defined in a peripheral edge portion of the epoxy substrate. Likewise, the second detection coil substrate 42 includes two y-coil substrates 421 which are laminated on each other in a conducting manner so as to sandwich the sensor core 3 from the upper and lower sides thereof. Each of those y-coil substrates 421 is formed in such a manner that the coil patterns 42a for formation of the y-axial direction component magnetic field detection coil are formed on a surface of an epoxy substrate, and through-holes 42b for terminals that connect the respective y-coil patterns 42a are defined in a peripheral edge portion of the epoxy substrate.

Also, the exciting coil substrate 5 includes two exciting coil substrates 51 and 52 which are laminated on each other in a conducting manner so as to sandwich the sensor core 3 from the upper and lower sides thereof. The respective exciting coil substrates 51 and 52 are formed in such a manner that exciting coil patterns 51a and 52a are formed on the surface of an epoxy substrate, and through-holes 51b and 52b for terminals that connect the respective exciting coil patterns are defined in the peripheral edge portion of the epoxy substrate.

The magnetic sensor 2 is formed by sequentially laminating the sensor core 3, the magnetic field detection coil substrate 4 and the exciting coil substrate 5 on the sensor core 3 in the stated order and then pressing those laminated members to form a laminate.

Reference numeral 6 denotes a CPU that conducts a given arithmetic operating process on the basis of a position signal inputted from the GPS receiving portion 1 and an orientation signal from the magnetic sensor 2 to measure the present position (the longitude, the latitude and the orientation). Then, the CPU 6 reads map information that coincides with the present position information from a map information storing portion 7 and displays the map information together with a present place index on a display 91 of a position information display portion 9. At the same time, the position information display portion 9 auditorially displays the present position, the orientation, etc., by a synthetic voice.

The positional information from the GPS receiving portion 1 and the orientation information from the magnetic sensor 2 conduct mutual complement. The orientation information can be obtained from a change in the positional information of the GPS receiving portion 1 with the movement of the portable terminal device through arithmetic operation. The orientation information and the orientation information from the magnetic sensor 2 are compared with each other, and if the orientation information from the magnetic sensor 2 is set to be positive, a start point can be found out. As a result, the positional information of the GPS receiving portion 1 can be returned to the start point, and the integrated and accumulated error information can be returned to 0.

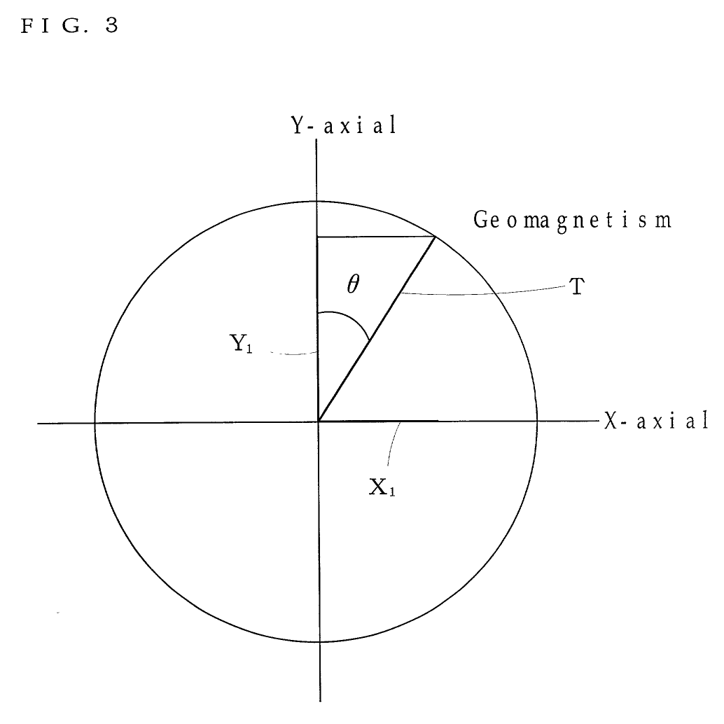

A map information display processing portion 8 subjects the map information of the present place displayed on the display 91 to rotation scroll by a required angle if necessary and processes the display in such a manner that the forward direction (directed to a direction of the magnetic sensor) of the present place index is always directed toward the upper side of the display 91 on the map information of the present place. A description will be given with reference to FIG. 3. The orientation signal from the magnetic sensor 2 is inputted to the CPU as the analog values obtained by decomposing the detected geomagnetism into an x-axial direction (zonal direction) magnetic field vector value and a y-axial direction (meridional direction) magnetic field vector value. The CPU analog-to-digital converts the input signal into a digital signal. The magnetic field vector values in the x-axial direction and the y-axial direction are enhanced in resolution by using a given correction parameter stored in an EEP-ROM. If the meridional direction is set to be 0°, the clockwise rotating angle (orientation angle) θ° which reaches the synthetic vector T (representative of a direction of the magnetic sensor) of the x-axial magnetic field vector value X₁ and the y-axial magnetic field vector value Y₁ is obtained by the following expression.

θ=tan⁻¹X₁/Y₁

The calculation of the orientation angle is enabled by a calculating logic not using the correction parameter for the magnetic field vector values in the respective directions.

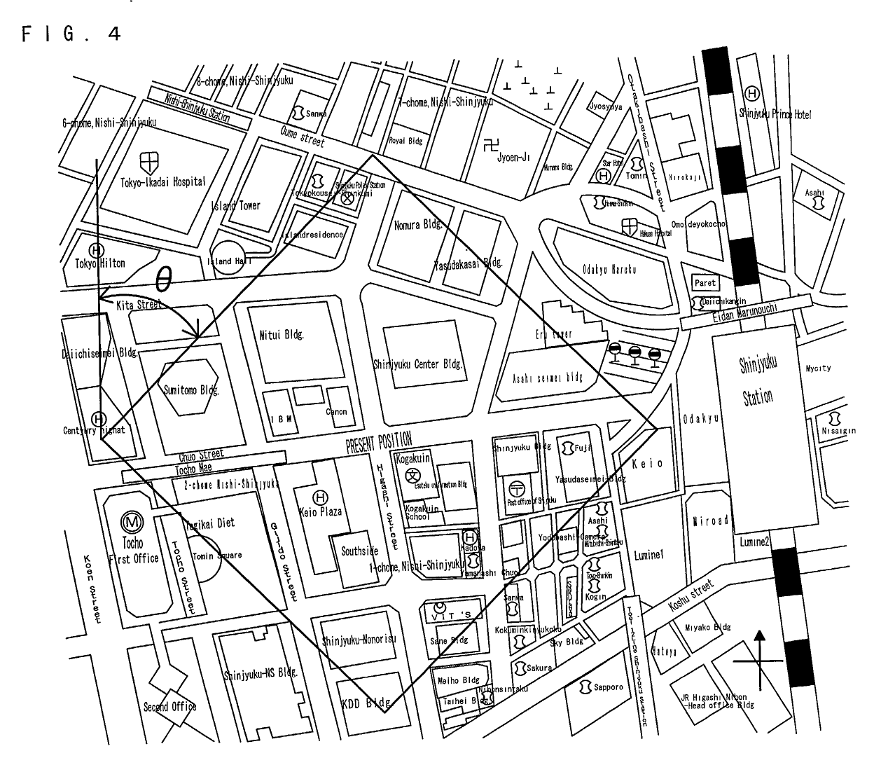

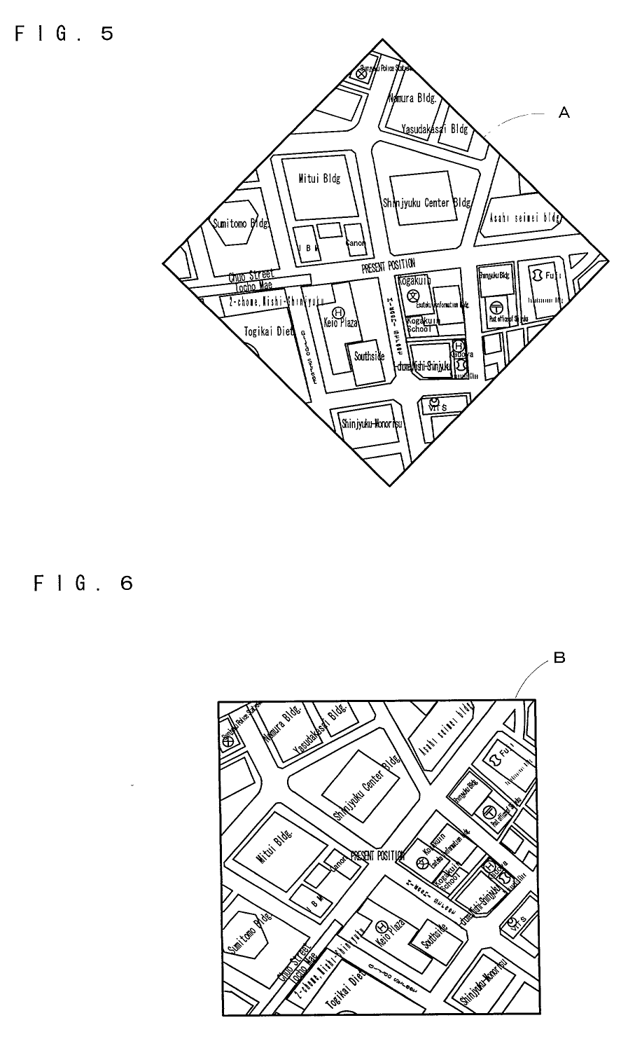

The processing steps of the map information display processing portion 8 will be described with reference to FIGS. 4 to 6. For example, it is assumed that a user of the portable terminal device now exists in a corner portion of Kogakuin University on a Chuo-street of Shinjuku station and is directed toward a direction of North-East (orientation angle is 45°). The map information of the longitude and the latitude in question (refer to FIG. 4) is read from the map information storing portion 7 in accordance with the position signal from the GPS receiving portion 1. Then, the map information in an area that matches the size of a display screen (for example, 200 dots×200 dots) with the present position P as a center is sectioned and selected. In this situation, the selected map information A is the map information in an area where it rotates by the orientation angle θ obtained by the orientation signal from the magnetic sensor 2 clockwise (refer to FIG. 5). Then, when the map information is displayed on the display 91, the map information A selected by the above display processing portion 8 is rotationally processed to the orientation angle counterclockwise direction and displayed in a corrected manner (refer to FIG. 6). As a result, the map information B becomes a map in which the direction (forward direction) of the magnetic sensor 2 is always directed toward the upper side of the display 91. Every time the orientation of the forward direction is changed with the movement of the portable terminal, the display processing portion 8 conducts the same processing as the above-described processing and displays the map information in which the forward direction is always directed toward the upper side of the display. Those sequential processings are conducted at a high speed and at a real time.

Also, the map information display processing portion 8 maintains the characters and the marks contained in the map information displayed on the display 91 at the original positional relation with respect to the upper side direction of the display without conducting any rotating process when the map information is rotationally processed on the basis of the orientation angle. In FIG. 6, the characters and so on are rotated by the orientation angle without conducting the above processing and displayed. The characters and the marks mentioned in a horizontal direction maintain a manner in which they are mentioned horizontally even in the case where the map information is rotationally displayed, likewise. As a result, the information of the characters, etc., is readily visible.

The destination may be inputted such as by using a key of the portable terminal device. In this case, the shortest route and the required period of time up to the destination are calculated on the basis of the map information and then displayed on the display of the position information display portion or by a voice output portion.

Also, if the positional information of the GPS receiving portion and the orientation information of the magnetic sensor which have been received or measured are temporarily stored, a locus along which the portable terminal device has moved can be confirmed on the basis of the stored information later.

As was described above, according to the present invention, the following advantages can be obtained.

Since a flux gate type magnetic sensor consisting of a sensor substrate in which a magnetic field detection coil substrate and an exciting coil substrate are laminated on the upper and lower surfaces of a sensor core, or a geomagnetic sensor using a hole element, a magnetic resistant element or the like is employed as the orientation detecting means used together with the GPS position detecting means, the accurate present position of a user can be displayed together with the map information on a display of a small-sized portable terminal device, in particular, a portable telephone.

Also, since the map information is subjected to rotating scroll by the map information processing means on the basis of the orientation angle obtained from the magnetic field vector value of the magnetic sensor, the map information can be displayed in such a manner that the forward moving direction of the portable terminal device is always directed toward the predetermined specified direction within a plane of the display portion, and the orientation of the map information coincides with the forward direction so that the user has no strange feeling and can dynamically understand the accurate orientation and position.

Further, since the positional information by the GPS is complemented by the orientation information by the geomagnetic sensor, the error information accumulated by the integrating system can be permanently eliminated so as to provide a position display system high in precision.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A positional information display system having a portable terminal device, said portable terminal device comprising:
position detecting means for detecting a position on the basis of a GPS signal;
orientation detecting means for detecting an orientation by a flux gate type magnetic sensor consisting of a sensor substrate in which a magnetic field detection coil substrate and an exciting coil substrate are laminated on the upper and lower surfaces of a sensor core, or a geomagnetic sensor using a hole element, a magnetic resistant element or the like;
arithmetically operating means for correcting the positional information detected by said position detecting means by said orientation detecting means;
map information storing means for storing map information therein;
positional information display means for displaying the present position decided on the basis of said arithmetically operating means together with the map information; and
display processing means for subjecting the map information displayed by said positional information display means to rotation scroll by the amount of changed angle on the basis of an output signal from said orientation detecting means with a change of orientation of the present position;
wherein when the orientation is changed by the movement of said portable terminal device, the map information is rotated by said display processing means, and the present position of said portable terminal device is displayed on the display portion of said positional information display means so that the forward moving direction is always directed toward the predetermined specific direction within the plane of the display portion.

2. The positional information display system as claimed in claim 1,
wherein the magnetic field detection coil substrate of the flux gate type magnetic sensor includes a first detection coil substrate having a coil pattern for formation of an x-axial component magnetic field detection coil and a second detection coil substrate having a coil pattern for formation of a y-axial component magnetic field detection coil;
wherein the exciting coil substrate includes an annular coil pattern for formation of an exciting coil; and
wherein through-holes which are connected to the respective coil patterns are defined in the edge portion of the sensor substrate.

3. The positional information display system as claimed in claim 1, wherein the present position of said portable terminal device is displayed so that the forward direction is always directed toward the upper side of the display portion within a plane of the display portion of said positional information display means.

4. The positional information display system as claimed in claim 1,
wherein said positional information display means includes visual display means such as an image or a character and auditory display means such as a voice; and
wherein the present position and/or the forward moving state are visually and auditorially displayed.

5. The positional information display system as claimed in claim 1, wherein when the map information displayed by said positional information display means is rotationally processed by said display processing means, the character contained in the map information maintains the positional relation which is before the map information is rotationally processed in the specified direction.

6. The positional information display system as claimed in claim 1,
wherein said magnetic sensor analyzes the geomagnetism into an x-axial magnetic field component and a y-axial magnetic field component and outputs those components as a signal of an analog value;
wherein said arithmetically operating means converts the analog signal into a digital signal to measure the orientation of the present place; and
wherein said display processing means rotates the map information in a required direction with an angle to the orientation of the present place in case where a magnetic north orientation is 0 degree as a rotating angle.

7. The positional information display system as claimed in claim 1, wherein said positional information display means displays the shortest route or a required period of time up to a designation.
